(19) United States
(12) Patent Application Publication
(10) Pub. No.: US 2025/0267472 A1
(43) Pub. Date: Aug. 21, 2025

(54) TECHNOLOGIES FOR MOBILITY ENHANCEMENT FOR NON-TERRESTRIAL NETWORKS

(71) Applicant: Apple Inc., Cupertino, CA (US)

(72) Inventors: Yuqin Chen, Beijing (CN); Fangli Xu, Beijing (CN); Peng Cheng, Beijing (CN); Haijing Hu, Los Gatos, CA (US); Chunxuan Ye, San Diego, CA (US); Dawei Zhang, Saratoga, CA (US); Jie Cui, San Jose, CA (US); Chunhai Yao, Beijing (CN)

(73) Assignee: Apple Inc., Cupertino, CA (US)

(21) Appl. No.: 18/949,778

(22) Filed: Nov. 15, 2024

Related U.S. Application Data
(60) Provisional application No. 63/554,629, filed on Feb. 16, 2024.

(51) Int. Cl. H04W 16/28; H04W 48/08; H04W 72/231; H04W 72/51; H04W 76/28

(52) U.S. Cl. CPC H04W 16/28; H04W 48/08; H04W 72/231; H04W 72/51; H04W 76/28

(57) ABSTRACT

The present application relates to devices and components including apparatus, systems, and methods for mobility enhancement and beam management for non-terrestrial networks.

### CROSS-REFERENCES TO OTHER APPLICATIONS

This application claims priority to U.S. Provisional Application No. 63/554,629, for “TECHNOLOGIES FOR MOBILITY ENHANCEMENT FOR NON-TERRESTRIAL NETWORKS” filed on Feb. 16, 2024, which is herein incorporated by reference in its entirety for all purposes.

### TECHNICAL FIELD

This application relates generally to communication networks and, in particular, to beam management for non-terrestrial networks.

### BACKGROUND

Third Generation Partnership Project (3GPP) Technical Specifications (TSs) define standards for wireless networks. These TSs describe aspects related to user plane and control plane signaling over the networks.

### BRIEF DESCRIPTION OF THE DRAWINGS

FIG. 1 illustrates a network environment in accordance with some embodiments.

FIG. 2 illustrates a timing diagram in accordance with some embodiments.

FIG. 3 illustrates another network environment in accordance with some embodiments.

FIG. 4 illustrates another timing diagram in accordance with some embodiments.

FIG. 5 illustrates another timing diagram in accordance with some embodiments

FIG. 6 illustrates another timing diagram in accordance with some embodiments.

FIG. 7 illustrates another network environment in accordance with some embodiments.

FIG. 8 illustrates an operation flow/algorithmic structure in accordance with some embodiments.

FIG. 9 illustrates another operation flow/algorithmic structure in accordance with some embodiments.

FIG. 10 illustrates another operation flow/algorithmic structure in accordance with some embodiments.

FIG. 11 illustrates another operation flow/algorithmic structure in accordance with some embodiments.

FIG. 12 illustrates a user equipment in accordance with some embodiments.

FIG. 13 illustrates a network node in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth, such as particular structures, architectures, interfaces, and techniques in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A/B” and “A or B” mean (A), (B), or (A and B); and the phrase “based on A” means “based at least in part on A,” for example, it could be “based solely on A” or it could be “based in part on A.”

The following is a glossary of terms that may be used in this disclosure.

The term “circuitry” as used herein refers to, is part of, or includes hardware components that are configured to provide the described functionality. The hardware components may include an electronic circuit, a logic circuit, a processor (shared, dedicated, or group) or memory (shared, dedicated, or group), an application specific integrated circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), or a digital signal processor (DSP). In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, and network interface cards.

The term “user equipment” or “UE” as used herein refers to a device with radio communication capabilities that may allow a user to access network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, or reconfigurable mobile device. Furthermore, the term “user equipment” or “UE” may include any type of wireless/wired device or any computing device including a wireless communications interface.

The term “computer system” as used herein refers to any type interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component within a computing environment, or a physical or virtual component within a particular device, such as computer devices, mechanical devices, memory space, processor/CPU time, processor/CPU usage, processor and accelerator loads, hardware time or usage, electrical power, input/output operations, ports or network sockets, channel/link allocation, throughput, memory usage, storage, network, database and applications, or workload units. A “hardware resource” may refer to compute, storage, or network resources provided by physical hardware elements. A “virtualized resource” may refer to compute, storage, or network resources provided by virtualization infrastructure to an application, device, or system. The term “network resource” or “communication resource” may refer to resources that are accessible by computer devices/systems via a communications network. The term “system resources” may refer to any kind of shared entities to provide services and may include computing or network resources. System resources may be considered as a set of coherent functions, network data objects, or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, or a virtualized network function.

The term “information element” refers to a structural element containing one or more fields. The term “field” refers to individual contents of an information element or a data element that contains content. An information element may include one or more additional information elements.

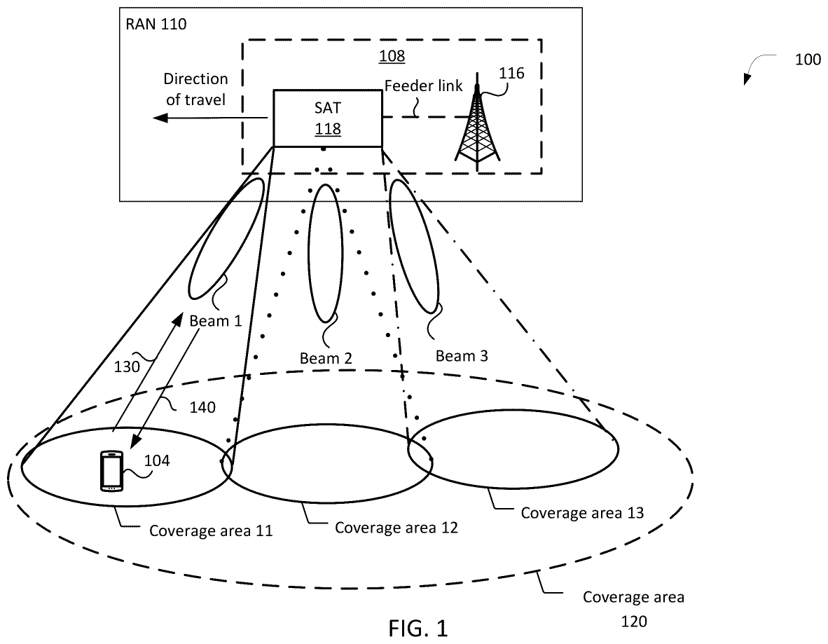

FIG. 1 illustrates a network environment 100 in accordance with some embodiments. In particular, the network arrangement 100 may employ one or more non-terrestrial components and may, therefore, be referred to as a non-terrestrial network (NTN).

The network environment 100 may include user equipment (UE) 104 communicatively coupled with base station 108 of a radio access network (RAN) 110. The UE 104 and the base station 108 may communicate over air interfaces compatible with 3GPP TSs, such as those that define a Fifth Generation (5G) new radio (NR) system or a later system. The base station 108 may provide user plane and control plane protocol terminations toward the UE 104.

The base station 108 may include various network nodes such as transmit-receive points (TRPs) to facilitate the provision of one or more serving cells that provide user plane and control plane protocol terminations toward the UE 104. In some embodiments, the base station 108 may include a ground node 116 and a non-terrestrial node 118.

The non-terrestrial node 118 may also be referred to as NTN payload (NP) to provide transmission and reception services with respect to the UE 104.

In some embodiments, NP 118 may facilitate the provision of an access link of the serving cells. The NP 118 device may be an earth-fixed satellite (such as a geosynchronous (GEO) earth orbit satellite or a high-altitude platform station (HAPS)), a quasi-earth-fixed satellite (such as a non-geostationary Earth orbit (NGEO) satellite with steerable beam), or an Earth-moving satellite (such as an NGEO with fixed or non-steerable beam). The NP 118 may facilitate a wireless connection between the ground node 116 and the UE 104 by relaying signals between the two network devices. The signals may be relayed over a feeder link between the NP 118 and the ground node 116 and a service link between the NP 118 and the UE 104.

NP 118, in some embodiments, may be a network node embarked on board the satellite or high-altitude platform station, providing connectivity functions between the service link and the feeder link. If the NP 118 functions as a transparent relay, it may be referred to as a transparent NP.

The NP 118 may provide radio access services through one or more serving cells for a geographical area of the coverage area 120. The coverage area 120 may be larger than a coverage area associated with a terrestrial network. Coverage area 120 may be across multiple jurisdictional boundaries in some embodiments.

The base station 108 may provide the coverage area through one or more beams. For example, beam 1 may provide coverage area 11, beam 2 may provide coverage area 12, and beam 3 may provide coverage area 13.

In some embodiments, all beams, e.g., beams 1-3, may have the same physical cell identifier (PCI). Having the same PCI may imply that all beams, e.g., beams 1-3, may belong to the same cell. The beams of the same cell, e.g., beams 1-3, may have the same synchronization signal block (SSB) or system information block (SIB). In some instances, each beam may have a separate paging message associated with the tracking area index (TAI). For example, different paging messages may be transmitted over different beams.

In one example, SIB may include the reference location of the coverage area 120, e.g., the center and radius information of the coverage area 120. Beams of the same cell, e.g., beams 1-3 having the same SIB, may share the same reference location. Even though beams 1-3 are associated with coverage areas 11-13, all are associated with the reference location of the coverage area 120. For example, the base station 108 may include the reference location information in the SIB 9.

In some instances, the SSB measurement timing configuration (SMTC) may include a list of SSBs to be measured. The base station 108 may configure the UE 104 with the list of SSBs to be measured through configuration signal 140. The list may include the indices of all the beams that the UE 104 is configured to measure. For example, the base station 108 may include the list of SSBs to be measured in SIB 2 or SIB 4. In some instances, the list of SSBs to be measured may include the index of all the beams in the whole coverage area 120 of the cell, e.g., beams 1-3.

The base station 108 may use SIB to configure SMTC. If all the beams share the same SIB, then all the UEs covered by different beams and in different coverage areas would have the same SMTC configuration. It is desirable to enable UEs in different coverage areas and associated with different beams to be able to measure and report SSBs that are relevant to them. In some embodiments, the SMTC configuration may be associated with a beam index so that the base station 108 may configure the beams with different SMTC configurations.

Due to power constraints at the NP 118, the available power is divided among all the beams, e.g., beams 1-3. It is desirable to allocate all the available power at the NP 118 to one beam at a time to increase the throughput and improve the network performance at each coverage area 11-13. A beam-hopping mechanism may allow a time division multiplexing (TDM) among beams 1-3. Beam-hopping may be referred to a framework in which one beam covers one specific area in a certain time manner. In one example, SSB may always be transmitted on all beams and may not follow the TDM beam hopping pattern.

In some embodiments, beam-hopping may be realized by mechanisms provisioned for network energy saving (NES), such as discontinuous transmission (DTX) or discontinuous reception (DRX), NES cell barring, or NES-based conditional handover.

In some embodiment, the beam-hopping framework may be implemented by a beam-specific configuration. For instance, the base station 108 may configure beam-specific DTX or DRX and may use activation or deactivation mechanisms to provide each beam with beam-specific time patterns to boost its DL coverage. The base station may use the configuration signaling 140 to configure, activate, or deactivate DTX/DRX at the UE 104.

The beam-specific DTX or DRX configurations are examples of beam-specific configurations. The beam-specific configuration may identify the active duration for a beam during which the base station 108 may perform DL transmission or UL reception on that beam. The beam-specific configuration may identify the non-active duration for a beam during which the base station 108 may not perform DL transmission or UL reception on that beam.

In some instances, the configuration signaling 140 may include radio resource control (RRC) configurations or information elements (IEs). In other instances, the configuration signaling 140 may include medium access control (MAC) control elements (CEs). In another instance, the configuration 140 may include downlink (DL) control information (DCI). The configuration signaling 140 may be transmitted using a physical downlink shared channel (PDSCH) or a physical downlink control channel (PDCCH).

In one embodiment, the UE 104 may switch beam and inform the base station 108 about the beam change. The UE 104 may start performing measurements on the new beam, generate a measurement report, and send them to base station 108.

In some embodiments, the UE 104 may send information to the base station 108. The UE 104 may generate measurement reports and transmit them to the base station 108. The UE 104 may determine one or more UE capability parameters and transmit them to the base station 108 in one or more UE capability reports. The UE 104 may use signaling 130 to send the information to base station 108. For example, the UE 104 may use RRC signaling, MAC CE, or uplink control information (UCI) to send information to the base station 108. The UE 104 may use a physical uplink (UL) shared channel (PUSCH), physical uplink control channel (PUCCH), or physical random access channel (PRACH) for transmission of the information to the base station 108.

In some embodiments, the base station 108 may configure each beam with beam-specific access barring indication. The beam-specific access barring indication may be used to control UE's access to a beam.

In some embodiments, the base station 108 may configure the UE 104 with location-based SSBs to be measured. Each SSB in the list of SSBs to be measured may be associated with an area. The UE 104 may measure one or more of the SSBs in the list of SSBs to be measured based on its current location and the location associated with the SSB.

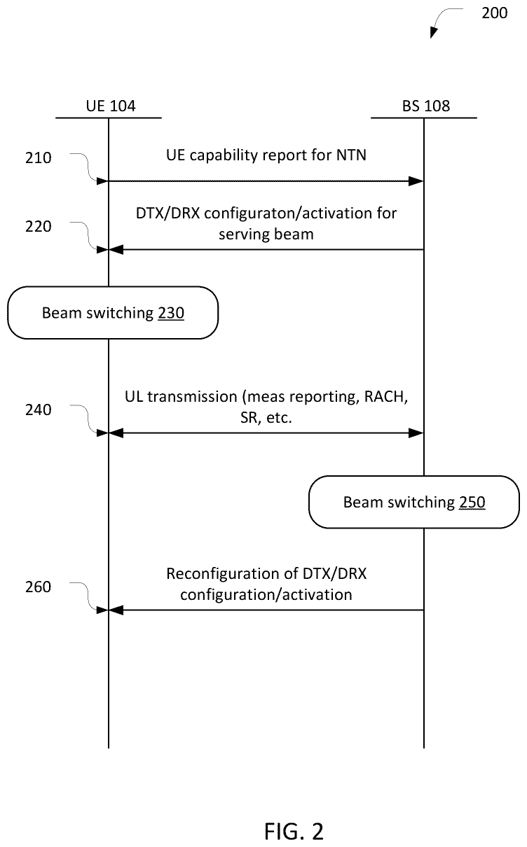

FIG. 2 is a timing diagram 200 illustrating aspects of beam-specific configuration in accordance with some embodiments. The timing diagram 200 may include operations performed by, and signaling messages transmitted between, the UE 104 and the base station 108. Operations described with respect to the base station 108 may be performed by one or more components of the RAN 110, including, for example, a base station 108, a ground station 116, an NP 118, a TRP, an NTN device, etc. The signaling diagram 200 represents an embodiment in which the base station 108 configures the UE 104 with beam-specific configuration.

At 210, the UE 104 may send the UE capability report to the base station 108. The UE capability report may include an NTN UE capability parameter associated with the support of beam-specific beam-hopping. The NTN UE capability parameter may indicate whether the UE 104 supports beam-specific configuration for NTN. The NTN UE capability parameter may indicate support of beam-specific configuration based on DTX or DRX configuration for NTN. The UE 104 may use RRC signaling to transmit the NTN UE capability parameter to the base station 108. The UE 104 may generate one or more UL packets to carry the RRC signaling and transmit them using PUSCH or PUCCH.

At 220, the base station 108, the base station 108 may determine to configure the UE 104 with beam-specific configuration on one or more of the configured beams. Each beam may have a different time pattern to boost DL coverage. The base station 108 may configure DTX or DRX configurations for the UE's serving beam. In one example, the configured DTX or DRX may also apply to other beams.

The base station 108 may activate or deactivate beam-specific configurations, e.g., DTX or DRX configurations. In one example, the base station 108 may configure the UE 104 with multiple beam-specific configurations, and the base station 108 may activate one of the configured beam-specific configurations. In one example, the base station 108 may activate or deactivate a beam-specific configuration by RRC signaling. In other examples, the base station 108 may activate or deactivate a beam-specific configuration by DCI. For example, the base station 108 may use NES DCI format 2-9. Alternatively, the base station 108 may use a dedicated DCI or MAC CE to activate or deactivate the beam-specific configurations for the serving beam. The serving beam may be the beam associated with the SSB index that the UE 104 uses for measurement or synchronization.

Once the UE 104 receives the beam-specific configuration and processes it, the UE 104 may perform DL reception or UL transmission according to the beam-specific configuration of the serving beam. In one example, the UE 104 operation may follow the NES DTX/DRX operation as described in Release 18 (Rel-18) of the 3GPP Technical Specifications (TSs).

Due to UE 104 mobility or the earth-moving cell provided by the NP 118, the UE 104 may leave the coverage area of a first beam, e.g., beam 1, and enter the coverage area of a second beam, e.g., beam 3. The UE 104 may switch its serving beam from the first beam, beam 1, to the second beam, e.g., beam 3.

Upon beam switching from the previous serving beam to the new serving beam, the UE 104 may consider the beam-specific configuration of the previous serving beam invalid. The UE 104 may generate a measurement report of the SSB of the new serving beam and transmit it to the base station 108 on the new serving beam. Additionally, or alternatively, the UE 104 may perform a random-access procedure on the physical random-access channel (PRACH) or generate and transmit a scheduling request in the new serving beam.

The base station 108 may initiate the beam-switching or may receive an indication regarding the beam-switching. At 250, the base station 108 may adjust its parameters and configurations based on the UE 104 new serving beam.

At 260, the base station 108 may transmit a reconfiguration message, including configurations or activation indicators of the new serving beam or deactivation indicator of the previous serving beam. In one example, when the beam-switching is due to the movement of the UE 104, the base station may send dedicated configuration messages to the UE 104. In another example, when the beam-switching is due to the earth-moving cell, the base station 108 may send a group message to all the UEs in the coverage area of the serving beam.

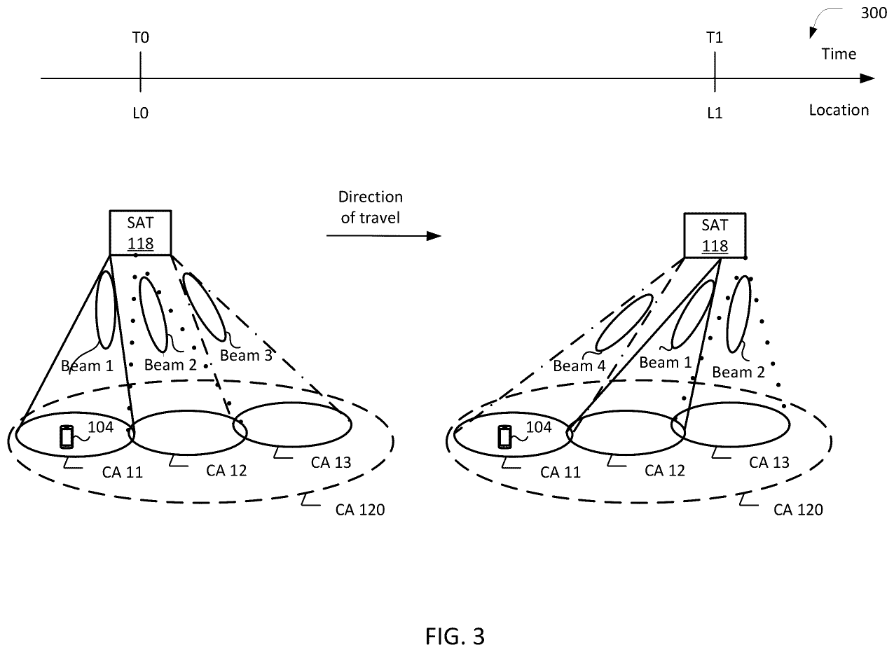

FIG. 3 illustrates another network environment 300 in accordance with some embodiments. The network environment 300 is an example of beam change due to satellite movement.

The NP 118 at time T0 is at location L0. At T0, the coverage area 11 (denoted by CA 11 in FIG. 3) is covered by beam 1, the coverage area 12 (CA 12) is covered by beam 2, and the coverage area 13 is covered by beam 3.

The NP 118 moves in the illustrated direction of travel. At time T1, the satellite is at location L1. At T1, the coverage area 11 is covered by beam 4, the coverage area 12 is covered by beam 1, and coverage area 13 is covered by beam 2.

At T0, the UE 104 is in coverage area 11 and being served by serving beam 1. At T1, the UE 104 is still in coverage area 11, however the coverage area 11 is now served by beam 4. At time T1, the UE 104 may no longer receive signals from beam 1. When the satellite moves and the beam covering an area changes, the base station 108 may signal beam switching to all UEs in a coverage area or UEs associated with a beam. For example, the base station 108 may send a group-common signaling to activate a new beam for a group of UEs.

In another example, the UE 104 may move from coverage area 11, associated with beam 1 at time T0, and enter the coverage area 12, associated with beam 2. The UE 104 may switch beam. Beam switching for a specific UE due to the UE movement may be signaled using dedicated signaling. For example, the base station 108 may use dedicated signaling to deactivate beam 1 and activate beam 2 for the UE 104.

In one embodiment, the UE 104 determines that it has to perform a beam-switching operation. The UE 104 may send measurement reports, perform a random-access procedure on PRACH, or send a scheduling request to the base station 108 before being reconfigured by the base station 108 with a new beam-specific configuration of the new beam. However, because the UE 104 has not received the beam 2 beam-specific configuration, the UE 104 transmissions may occur during the non-active duration of the base station 108.

In some embodiments, the base station 108 may configure the UE 104 with multiple sets of beam-specific configurations. In some instances, each beam-specific configuration may be associated with one beam. In some instances, each beam may be associated with multiple beam-specific configurations. The base station 108 may use the RRC signaling to configure the UE 104 with one or more beam-specific configurations.

In one example, the beam-specific configurations may include DTX or DRX configurations. The base station 108 may configure the UE 104 with one or more DTX or DRX configurations. One or more DTX or one or more DRX configurations may be associated with a beam, e.g., with beam index or SSB index. The base station 108 may use the RRC signaling to configure the UE 104 with one or more DTX or DRX configurations.

In one example, the beam-specific configuration may be associated with a beam when it is associated with a beam index or SSB index associated with the beam. For example, the beam-specific configuration may include a field associated with the SSB index or the beam index.

The base station 108 may explicitly activate one beam-specific configuration for a beam. The activation may be dedicated to a UE, e.g., the UE 104, or it may be group common activation for UEs within a coverage area, e.g., coverage area 11. For example, the activation signaling may include an index or an indication associated with a configuration that is being activated. For example, the activation signaling may activate one of the configured DTX or DRX configurations associated with an SSB index.

The base station 108 may switch the UE 104 from one serving beam, e.g., beam 1, to a new beam, e.g., beam 3. The base station 108 may send a configuration to the UE 104, including an indication of the new beam. The base station 108 may also send to the UE 104 an activation of a beam-specific configuration of the new beam.

In one embodiment, the base station 108 may use the serving beam to signal beam-switching to the UE 104. The base station 108 may use PDCCH to transmit the beam-switching signaling to the UE 104. The base station 108 may use UE-specific MAC CE to activate a beam-specific configuration. The UE-specific MAC CE may be transmitted on the serving beam to which the UE 104 is associated.

In one example, the base station 108 may use transmission configuration indicator (TCI) state activation MAC CE to activate a beam-specific configuration. The activation of the new beam-specific configuration may imply beam-switching to the UE 104. The TCI state activation MAC CE may include an indication of the SSB index or an indication corresponding to the beam-specific configuration to be activated for the new beam.

In another example, the base station 108 may use a new dedicated MAC CE to activate one of the beam-specific configurations, e.g., DTX or DRX configurations. In one example, the beam-specific configuration may be associated with a beam, and the activation of a configuration may imply switching the beam to the beam associated with the activated configuration. The UE 104 may receive and process the MAC CE, switch its beam accordingly, and apply the beam-specific configuration, e.g., the DTX or DRX configurations.

In one embodiment, the base station 108 may use a new UE-specific DCI to indicate the index of activated beam-specific configuration, e.g., the index of DTX or DRX configurations, to the UE 104. The UE-specific DCI may be transmitted on the serving beam to which the UE 104 is associated. The activation of a new beam-specific configuration may imply switching the serving beam to the beam associated with the activated configuration.

In one embodiment, the base station 108 may use a new group common DCI or group common MAC CE to indicate the index of activated beam-specific configuration, e.g., the index of DTX or DRX configurations, to a group of UEs. The group common DCI or MAC CE may be transmitted on the serving beam to which the UEs are associated. The activation of a new beam-specific configuration may imply group-common switching of the serving beam to the beam associated with the activated configuration. The group common signaling may save signaling and latency to avoid UE blind re-selecting a new beam.

In one embodiment, the UE 104 may be configured with a time duration to allow tuning the radio frequency (RF) circuitry. During the time duration, the UE 104 may not be expected to receive any DL transmission from the old or new serving beam. During the time duration, the UE 104 may not be expected to be scheduled for UL transmission to the old or the new beam.

In one embodiment, the base station 108 may configure the UE 104 with one or more beam-specific configurations associated with one or more beams. In one example, each beam may be associated with only one beam-specific configuration. In another example, each beam may be associated with more than one beam-specific configuration.

The UE 104 may determine a condition and autonomously switch its beam based on the condition. The condition for triggering beam switching may be based on channel conditions. For example, the target beam layer 1 (L1) measurement may be better than the L1 measurement of the current serving beam. The UE 104 may switch its serving beam to the target beam. The L1 measurement may be the reference signal received power (RSRP), reference signal received quality (RSRQ), or signal-to-interference-and-noise ratio (SINR) that are measured using the SSB of the serving beam and configured neighbor beams.

In some instances, the UE 104 may determine that the measurement of the target beam is better than the measurement of the current serving beam based on one or more thresholds. For example, the UE 104 may determine that the measurement of the target beam is better than the measurement of the current serving beam when the RSRP of the target beam is larger than the RSRP of the serving beam by a first threshold; or when the RSRQ of the target beam is larger than the RSRQ of the serving beam by a second threshold; or when the SINR of the target beam is larger than the SINR of the serving beam by a third threshold. The base station 108 may configure the first, second, or third thresholds.

In some instances, the UE 104 may initiate beam-switching when the measurement of the target beam is larger than a threshold. For example, the UE 104 may initiate beam switching when the RSRP of the target beam is larger than a first threshold; when the RSRQ of the target beam is larger than a second threshold; or when the SINR of the target beam is larger than a third threshold. The base station 108 may configure the first, second, or third thresholds.

The UE 104 may trigger reporting the measurement results of the target beams based on the configured thresholds or determining that a measurement of the target beam is better than the measurement of the serving beam. In some instances, the UE 104 may transmit the measurement result of the target beam using the target beam. In other instances, the UE 104 may transmit the measurement results of the target beam using the current serving beam.

The UE 104 may determine another condition and autonomously switch its beam based on whether the target beam is in normal mode or uses a beam-specific configuration. A configured beam that is not associated with a beam-specific configuration may operate in normal mode. A beam in normal mode is always in an active state, and the base station 108 may perform DL transmission or UL reception on a normal beam at any given time.

In some instances, the base station 108 may provide multiple sets of DTX or DRX configurations to the UE 104 for different SSB indices using RRC signaling. The UE 104 may autonomously perform switching on beams.

Once the UE 104 autonomously switches its beam from a serving beam to a new serving beam, the UE 104 may indicate the beam-switching to the base station 108. The UE 104 may generate the indication and send it to the base station 108 during the active duration of the beam-specific configuration associated with the new serving beam. In some instances, the UE 104 may use a scheduling request, a sounding reference signal, a random-access preamble, or a UL PUCCH or PUSCH on a configured grant to indicate the beam-switching to the base station 108. The UE 104 may provide the beam index, or an indication associated with the beam-specific configuration to the base station 108. For example, the UE 104 may provide an index of the DTX or DRX pattern or configuration associated with the new serving beam to the base station 108.

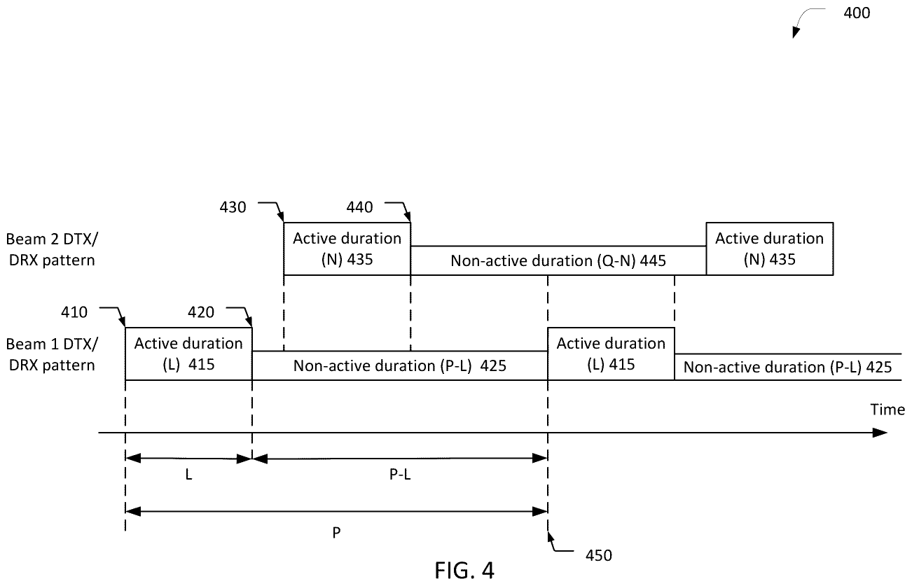

FIG. 4 illustrates another timing diagram 400 in accordance with some embodiments. The timing diagram 400 is an example of beam-specific configuration.

At 410, the active duration 415 of the beam-specific configuration of beam 1 may begin. The active duration 415 may last for L seconds(s).

At 420, the active duration 415 of the beam-specific configuration of beam 1 may end, and the non-active duration 425 may begin. The non-active duration 425 may last for P-L(s). The beam-specific configuration may have a periodicity of P(s), and the same pattern of active duration and non-active duration may repeat once every P(s).

At 430, while beam 1 is in non-active duration 425, the active duration 435 of the beam-specific configuration of beam 2 may begin. The active duration 435 may last for N(s). In one example, the duration of active durations 415 and 435 are the same, e.g., L=N. In one example, the duration of active duration 415 and 435 may not be the same, e.g., L≠N.

At 440, the active duration 435 of the beam-specific configuration of beam 2 may end, and the non-active duration 445 may begin. The non-active duration 445 may last for Q-N(s). The beam-specific configuration may have a periodicity of Q(s), and the same pattern of active duration and non-active duration may repeat once every Q(s). In one example, the periodicity of the beam-specific configuration of beam 1 may be the same as the periodicity of the beam-specific configuration of beam 2, e.g., P=Q. In one example, the periodicity of the beam-specific configuration of beam 1 may be the same as the periodicity of the beam-specific configuration of beam 2, e.g., P≠Q.

At 450, while beam 2 is in non-active duration 445, the active duration 415 of the beam-specific configuration of beam 1 may begin and last for L(s).

The UE 104 autonomous beam switching may be used when the UE 104 leaves the coverage area of one beam and enters the coverage area of another beam due to the UE 104 mobility. The UE 104 may determine which beam has a better channel measurement quicker than the base station 108. The UE 104 autonomous beam switching may be used when the overlap between coverage areas is small, and the UE 104 may be covered by multiple beams only for a short period. The base station 108 may not be able to reach the UE 104 on the serving beam and may only reach the UE 104 on the new beam of the new coverage area.

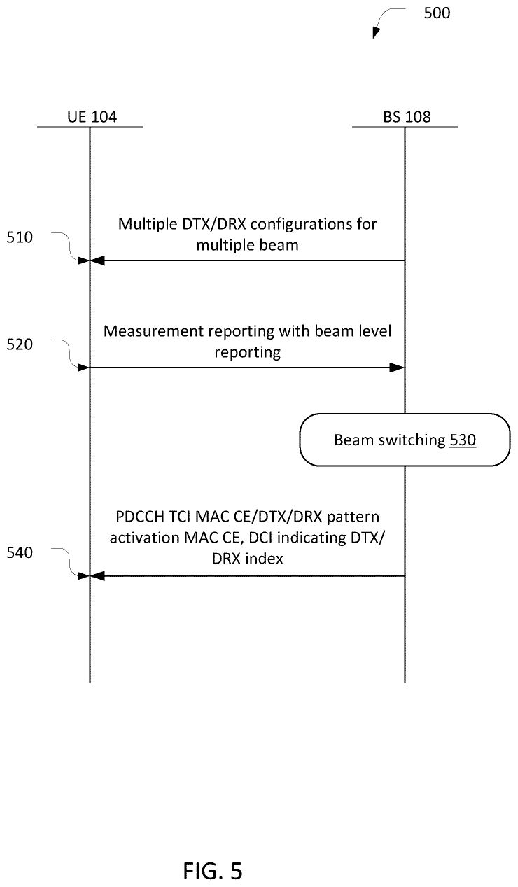

FIG. 5 illustrates another timing diagram 500 in accordance with some embodiments. The timing diagram 500 is an example of the network indication of a beam-specific configuration for one UE.

At 510, the base station 108 may configure the UE 104 with multiple beam-specific configurations for multiple beams. In one instance, each beam may be associated with a beam-specific configuration. A beam-specific configuration may be a DTX or DRX configuration. The DTX or DRX configuration may include one or more active or non-active patterns. The UE 104 may receive and process the configuration and perform the UL transmission and DL reception based on the configuration of the serving beam.

The UE 104 may perform measurements on configured beams. For example, the UE 104 may perform L1-RSRP, L1-RSRQ, or L1-SINR measurements on configured beams. The UE 104 may generate one or more measurement reports and transmit them to the base station 108.

The base station 108 may receive the beam level measurement reports. Based on the measurement reports, at 530, the base station 108 may determine whether the UE 104 should switch its serving beam. The base station 108 may determine that the UE 104 should switch its serving beam to a target beam.

At 540, the base station 108 may send a deactivation command to deactivate the current serving beam of the UE 104. The base station 108 may send an activation command to the UE 104 to activate the beam-specific configuration of the target beam. In one example, the activation command may implicitly operate as a deactivation command. Upon receipt and process of the activation command, the UE 104 may deactivate the current serving beam and activate the target beam indicated by the activation command.

In one example, the base station 108 may use TCI MAC CE to activate the DTX or DRX patterns associated with a target beam. In another example, the base station 108 may use DCI to activate the DTX or DRX patterns. The base station 108 may send the activation command in the DCI or MAC CE on a PDCCH. The activation command may include an index associated with the DTX or DRX configurations.

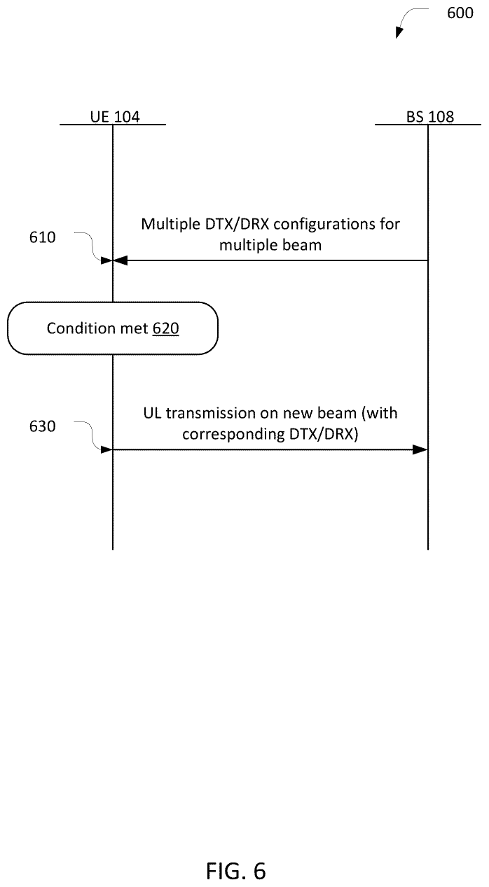

FIG. 6 illustrates another timing diagram 600 in accordance with some embodiments. The timing diagram 600 is an example of the UE 104 autonomous selection of a beam-specific configuration.

At 610, the base station 108 may configure the UE 104 with multiple beam-specific configurations for multiple beams. In one instance, each beam may be associated with a beam-specific configuration. A beam-specific configuration may be a DTX or DRX configuration. The DTX or DRX configuration may include one or more active or non-active patterns. The UE 104 may receive and process the configuration and perform the UL transmission and DL reception based on the configuration of the serving beam.

At 620, the UE determines whether the condition for beam switching is satisfied. The UE may determine that the condition for beam switching is satisfied. The condition for beam switching may be the L1 measurements associated with the configured target beams and the serving beam. Another condition may be whether the serving beam is configured with beam-specific configuration and one or more neighbor beams are configured with normal operation, e.g., without beam-specific configuration. The UE 104 may determine the new serving beam and switch its RF circuitry based on the configuration of the new serving beam.

At 630, the UE 104 may send an UL transmission on the new serving beam. The UE 104 may apply the beam-specific configuration associated with the new serving beam and perform the UL transmission according to the beam-specific configuration.

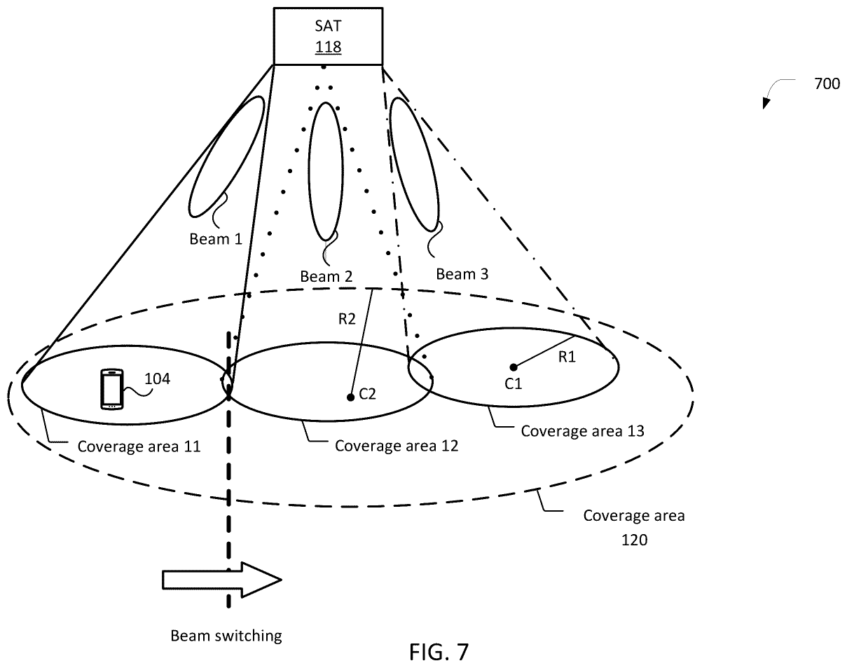

FIG. 7 illustrates another network environment 700 in accordance with some embodiments. The network environment 700 is an example of beam-switching.

The UE 104 may be configured with NES specific list of barred cells. For example, SIB 1 may include a cell-barred field, including a list of barred cells.

Cell barring may be used to restrict access to certain cells. The barring may be specific to a UE, e.g., the UE 104, or may be common to a group of UEs. The cell barring may prevent the barred UEs from attempting to connect to the cell. For example, one or more UEs may be barred from accessing the cell due to some condition, such as congestion or maintenance.

In some instances, the NTN may have different congestion status in different locations, e.g., due to different user densities. It is desirable to allow different access barring configurations on different beams.

In some embodiments, the base station 108 may configure the UE 104 with a beam-specific access barring indication. The access barring indication may be beam-specific by being associated with a beam index or an SSB index. The base station 108 may use cell-barred indication, cell-barred NES indication, or user access control (UAC) configuration to implement beam-specific access barring indication. For example, the base station 108 may configure the UE 104 with a beam-specific cell barred indication, a beam-specific cell barred NES indication or a beam-specific UAC configuration.

The base station 108 may use SIB, e.g., SIB 1 or SIB 19, to configure the beam-specific access barring indication. For example, the SIB may include a first list of access barring indications associated with a first SSB index (beam 1), a second list of access barring indications associated with the second SSB index (beam 2), and a third list of access barring indications associated with the third SSB index (beam 3). The SIB is transmitted on all beams.

In other embodiments, different master information block (MIB) or SIBs may be transmitted on different beams. For example, a first MIB or a first group of SIBs may be transmitted on beam 1, which is different from a second MIB or a second group of SIBs transmitted on beam 2. Similarly, a first MIB or first group of SIBs may be transmitted on beam 1, which is different from a third MIB or a third group of SIBs transmitted on beam 3.

Having its own MIB or SIB, the base station 108 may configure each beam independently from one another. After a beam switch to a new serving beam, the UE 104 may need to acquire MIB or SIB of the new serving beam. Similarly, when the UE 104 camps on a beam associated with an SSB index, the UE 104 may need to acquire the MIB or SIB of that beam.

Different beams may sometimes be operated by different public land mobile network (PLMN). Each PLMN may implement its own UAC configuration. A PLMN-specific UAC configuration may be used as beam-specific access barring indication.

In some instances, the base station 108 configures the UE 104 with a list of SSB indices. The UE 104 may perform measurements on the SSBs in the configured list of SSB indices and report measurement results to the base station 108. The list of SSB indices may be included in an SSB-to-measure IE in SSB measurement timing configuration (SMTC). The SMTC configuration may be included in SIB, e.g., SIB 2 or SIB 4. The SSB-to-measure IE may be included in a measurement object configuration. The measurement object configuration may be included in RRC configurations.

In some embodiments, each SSB index may be associated with area information. The area information may include the beam coverage center and radius. For example, the SSB index of beam 3 may be associated with the center of coverage area 13, C1, and the radius of the coverage area 13, R1. For example, each SSB index in the SSB-to-measure IE in SIB may be associated with one or more area information. The UE 104 may perform location-based measurements based on its location and the area information of SSB indices.

In some instances, the base station 108 may provide the area information of the coverage area 120, e.g., center information, C2, and radius, R2. The base 108 may provide the area information of coverage areas 11, 12, and 13 associated with beams 1, 2, and 3, e.g., coverage area 13 center, C1, and radius R1, etc.

The UE 104 may determine its location information, e.g., using a global navigation satellite system (GNSS). Using its location and area information of an SSB index, the UE 104 may determine whether it is within the coverage area associated with the SSB index. The UE 104 may perform measurement on an SSB index when the UE 104 is within the coverage area associated with the SSB index. In some instances, the UE 104 may determine that it is within the coverage area associated with an SSB index when the distance between the UE 104 and the center of the coverage area is smaller than the radius of the coverage area.

In some instances, the UE 104 may perform measurement on the SSB index when the UE 104 is near the coverage area associated with the SSB index. The UE 104 may determine that it is near the coverage area associated with an SSB index when the distance between the UE 104 and the center of the coverage area is larger than the radius of the coverage area but smaller than a predefined threshold.

In some embodiments, the UE 104 may apply the location-based measurement described above when the UE 104 is in an RRC idle or inactive state.

When UE 104 is in an RRC connected mode, the UE 104 may report measurement results. The UE 104 may report measurement results associated with SSB indices in the list of SSBs in the SSB-to-measure IE in the RRC measurement object configuration.

In some embodiments, the base station 108 may suggest the UE 104 to report measurement results of a subset of SSBs in the list of SSBs. The base station 108 may determine the subset of SSBs based on the location of the UE 104 and the area information associated with each beam. In some instances, the base station may use assistance information when configuring the measurement object IE to the UE 104 to configure SSB indices for coverage areas that are near the UE 104.

In some embodiments, the UE 104 may perform location-based reporting based on its location and the area information of SSB indices.

The UE 104 may determine its location information, e.g., using a global navigation satellite system (GNSS). Using its location and area information of an SSB index, the UE 104 may determine whether it is within the coverage area associated with the SSB index. The UE 104 may generate a report for measurement results on an SSB index when the UE 104 is within the coverage area associated with the SSB index. In some instances, the UE 104 may determine that it is within the coverage area associated with an SSB index when the distance between the UE 104 and the center of the coverage area is smaller than the radius of the coverage area.

In some instances, the UE 104 may generate a report for measurement results on the SSB index when the UE 104 is near the coverage area associated with the SSB index. The UE 104 may determine that it is near the coverage area associated with an SSB index when the distance between the UE 104 and the center of the coverage area is larger than the radius of the coverage area but smaller than a predefined threshold.

In some embodiments, the UE 104 may determine the list of SSB indices that it can detect. The UE 104 may only measure and report the SSB indices that it can detect.

In some embodiments, the beam-switching is triggered based on the location of the UE 104. For example, the base station 108 may determine, based on the location information of the UE 104 and the area information of the beams, that the UE 104 has moved from the coverage area of one beam, the initial serving beam, to the coverage area of another beam, the target beam. The base station 108 may deactivate the initial serving beam, activate the target beam, and configure the UE 104 with the beam-specific configuration of the target beam.

In another example, the UE 104 may determine, based on its location information and the area information of the configured beams, that it has moved from the coverage area of one beam, the initial serving beam, and has entered the coverage area of another beam, the target beam. The UE 104 may switch its serving beam to the target beam and send an indication to the base station 108 to indicate the beam-switching.

In some instances, the UE 104 may perform a random-access procedure when it changes the beam from its current serving beam to a target beam. For example, the UE 104 may send a random-access preamble, e.g., message 1, when the UE 104 switches its serving beam. The UE 104 may send message 1 using the target beam.

In some instances, the UE may initiate a measurement report once the measurement result of the target beam is better than the measurement result of the serving beam. The UE 104 may determine that the measurement of the target beam is better than the measurement of the current serving beam when the RSRP of the target beam is larger than the RSRP of the serving beam by a first threshold; or when the RSRQ of the target beam is larger than the RSRQ of the serving beam by a second threshold; or when the SINR of the target beam is larger than the SINR of the serving beam by a third threshold. The base station 108 may configure the first, second, or third thresholds.

In some instances, the UE 104 may initiate a measurement report of the target beam when a measurement of the target beam exceeds a predetermined level. For example, the UE 104 may initiate reporting the target beam measurement results when the RSRP of the target beam is larger than a first threshold; when the RSRQ of the target beam is larger than a second threshold; or when the SINR of the target beam is larger than a third threshold. The base station 108 may configure the first, second, or third thresholds.

In some instances, the UE 104 may use the MAC CE report to report the measurement results of the target beam. The UE 104 may trigger the generating and transmission of the MAC CE report based on the location change of the UE 104 or a beam-switching. The UE 104 may transmit the MAC CE report on the target beam.

In the above examples, the UE 104 may perform the random-access procedure or report measurement results irrespective of whether the beam-switching was initiated by the base station 108 or autonomously by the UE 104.

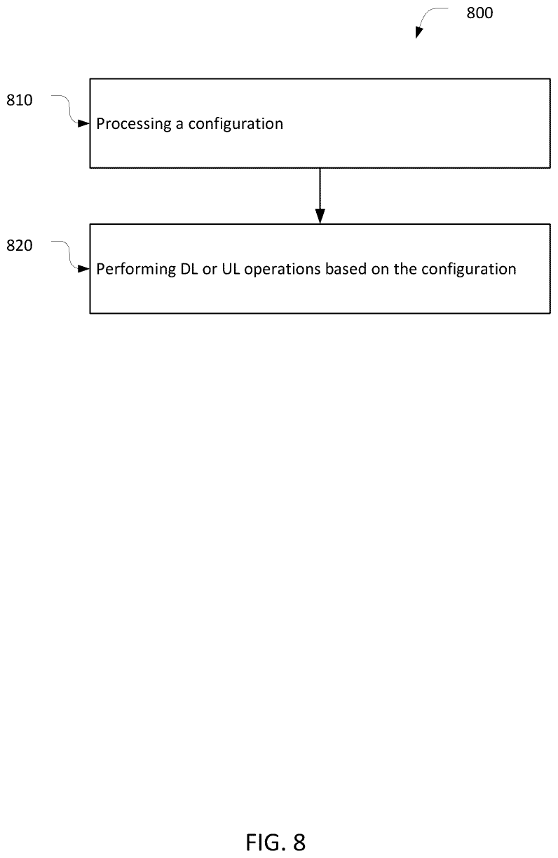

FIG. 8 illustrates an operational flow/algorithmic structure 800 in accordance with some embodiments. The operation flow/algorithmic structure 800 may be performed or implemented by a UE such as, for example, the UE 104 or UE 1200; or components thereof, for example, baseband processor circuitry 1204A.

The operation flow/algorithmic structure 800 may include, at 810, processing a configuration. The UE 104 may receive the configuration from the base station 108. The configuration may be a beam-specific configuration of a serving beam.

The beam-specific configuration may include a configuration associated with a beam-specific discontinuous transmission (DTX), a configuration of a beam-specific discontinuous reception (DRX), a configuration associated with a beam-specific DTX and a beam-specific DRX, or a configuration including an active duration and a non-active duration associated with the DL transmission and UL reception on the serving beam.

The UE 104 may receive more than one beam-specific configuration. Each beam may be associated with one or more beam-specific configurations. To associate a beam-specific configuration with a beam, the beam-specific configuration may include the beam index or SSB index associated with the beam. A beam-specific configuration may include one or more beam indices or one or more SSB indices; e.g., a beam-specific configuration may be associated with one or more beams.

The UE 104 may determine the UE capability parameter associated with supporting the beam-specific configuration. For example, the UE capability may indicate that the UE 104 may support beam-specific configuration. The UE 104 may generate a UE capability report, including the UE capability parameter associated with supporting the beam-specific configuration, and transmit the generated UE capability report to the base station 108.

The UE 104 may receive an activation command from the base station 108. The activation command may include an indication of a beam-specific configuration to be activated and applied by the UE 104.

The UE 104 may receive a deactivation command from the base station 108. The deactivation command may include an indication of a beam-specific configuration to be deactivated or disabled by the UE 104.

The UE 104 may switch its serving beam from the current serving beam to a target beam. The beam-switching operation may be triggered by the base station 108, or the UE 104 may autonomously perform the beam-switching operation.

When the UE 104 switches the beam from its current serving beam to a target beam, the UE 104 may determine that the beam-specific configuration of the current serving beam is no longer valid. The base station 108 may configure the UE 104 with a beam-specific configuration of the target beam or may activate the previously configured beam-specific configuration of the target beam.

The operation flow/algorithmic structure 800 may include, at 820, performing DL or UL operations based on the configuration. The beam-specific configuration may include active duration. During the active duration, the UE 104 may receive DL transmission from the base station 108. During the active duration, the UE 104 may transmit UL transmissions to the base station 108.

For example, the active duration may include one or more DRX active duration, one or more DRX non-active duration, one or more DTX active duration, or one or more DTX non-active duration. The UE 104 may perform UL transmission or DL reception based on the DTX or DRX configurations. In some instances, the active duration of the configured DTX or DRX may be the same as the active duration of the beam-specific configuration.

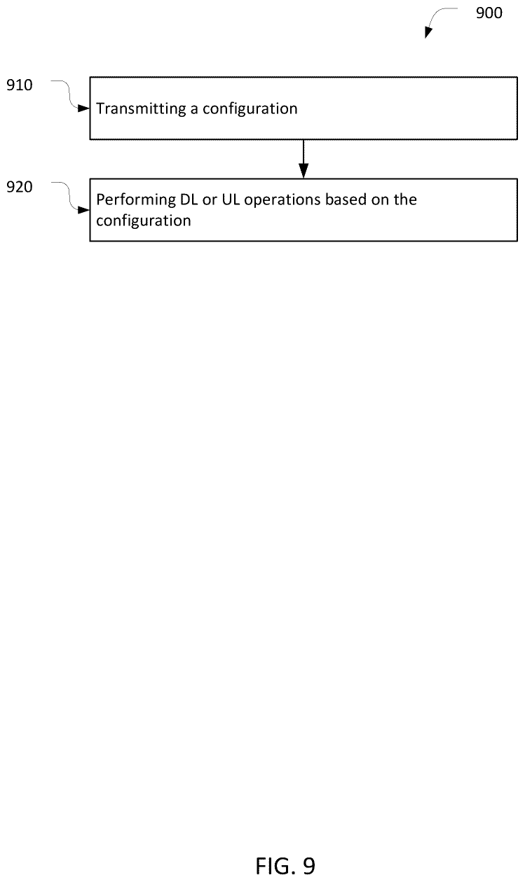

FIG. 9 illustrates an operation flow/algorithmic structure 900 in accordance with some embodiments. The operation flow/algorithmic structure 900 may be performed or implemented by a base station such as, for example, the base station 108 or the base station 1300; or components thereof, for example, baseband processor circuitry 1304A.

The operation flow/algorithmic structure 900 may include, at 910, transmitting a configuration. The base station 108 may transmit the configuration to the UE 104. The configuration may be a beam-specific configuration of a serving beam.

The beam-specific configuration may include a configuration associated with a beam-specific discontinuous transmission (DTX), a configuration of a beam-specific discontinuous reception (DRX), a configuration associated with a beam-specific DTX and a beam-specific DRX, or a configuration including an active duration and a non-active duration associated with the DL transmission and UL reception on the serving beam.

The base station 108 may configure the UE 104 with more than one beam-specific configuration. Each beam may be associated with one or more beam-specific configurations. The beam-specific configuration may include the beam index or SSB index associated with a beam to associate a beam-specific configuration with the beam. A beam-specific configuration may include one or more beam indices or one or more SSB indices; e.g., a beam-specific configuration may be associated with one or more beams.

The base station may receive a UE capability report from the UE 104. The UE capability report may include capability parameters associated with supporting the beam-specific configuration. For example, the UE capability may indicate that the UE 104 may support beam-specific configuration.

The base station 108 may transmit an activation command to the UE 104. The activation command may include an indication of a beam-specific configuration to be activated and applied by the UE 104.

The base station 108 may transmit a deactivation command to the UE 104. The deactivation command may include an indication of a beam-specific configuration to be deactivated or disabled by the UE 104.

The operation flow/algorithmic structure 900 may include, at 920, performing DL or UL operations based on the configuration. The beam-specific configuration may include active duration. During the active duration, the base station 108 may receive UL transmission from the UE 104. During the active duration, the base station 108 may transmit DL transmissions to the UE 104.

In some instances, the active duration may include one or more DRX active duration, one or more DRX non-active duration, one or more DTX active duration, or one or more DTX non-active duration. The base station 108 may perform DL transmission or UL reception based on the DTX or DRX configurations. In some instances, the active duration of the configured DTX or DRX may be the same as the active duration of the beam-specific configuration.

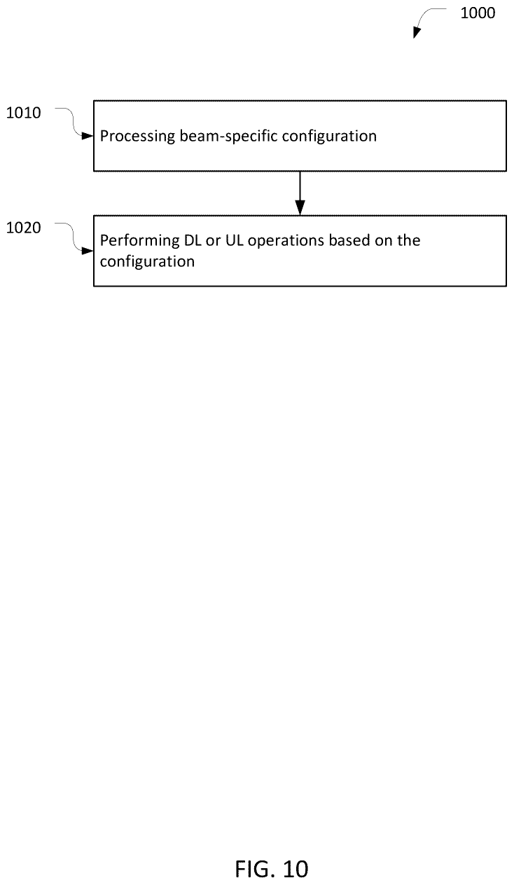

FIG. 10 illustrates an operation flow/algorithmic structure 1000 in accordance with some embodiments. The operation flow/algorithmic structure 1000 may be performed or implemented by a UE such as, for example, the UE 104 or UE 1200; or components thereof, for example, baseband processor circuitry 1204A.

The operation flow/algorithmic structure 1000 may include, at 1010, processing a beam-specific configuration. The beam-specific configuration may include beam-specific access barring indication associated with a serving beam.

The beam-specific access barring indication may include a beam-specific cell barred indication, a beam-specific cell barred network energy saving (NES) indication, or a beam-specific user access control (UAC) indication.

Each beam may be configured with a beam-specific access barring configuration. In one example, the beam-specific access barring configurations of all beams are included in SIB, and the SIB is transmitted on all beams. In one example, each beam has its own SIB or MIB. The SIB associated with a first beam may only be transmitted on the first beam, and the SIB associated with a second beam may only be transmitted on the second beam. The SIB associated with a beam may include the beam-specific access barring configuration associated with that beam.

The operation flow/algorithmic structure 1000 may include, at 1020, performing DL or UL operations based on the beam-specific configuration. If a UE is barred from accessing a beam, the UE may not perform UL transmission on that beam. Similarly, the base station may not schedule a barred UE to receive DL transmission on that beam.

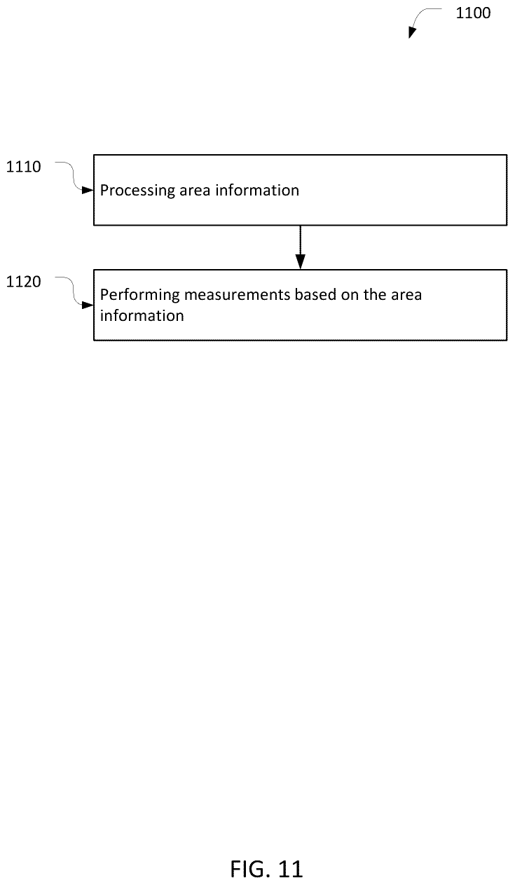

FIG. 11 illustrates an operation flow/algorithmic structure 1100 in accordance with some embodiments. The operation flow/algorithmic structure 1100 may be performed or implemented by a UE such as, for example, the UE 104 or UE 1200; or components thereof, for example, baseband processor circuitry 1204A.

The operation flow/algorithmic structure 1100 may include, at 1110, processing area information. The area information may be associated with a beam index. The area information may indicate the coverage area associated with the beam. The area information may include center information determining the center of the coverage area and radius information determining the radius of the coverage area.

The operation flow/algorithmic structure 1100 may include, at 1120, performing measurements based on the area information.

In some instances, the UE 104 may determine that it is within the coverage area associated with a beam. In other instances, the UE 104 may determine that it is near the coverage area of a beam.

The UE 104 may perform measurement or measurement reporting associated with a beam based on its location. For example, the UE 104 may perform measurement or measurement reporting associated with a beam based on a determination that the UE is within or near the coverage area of that beam.

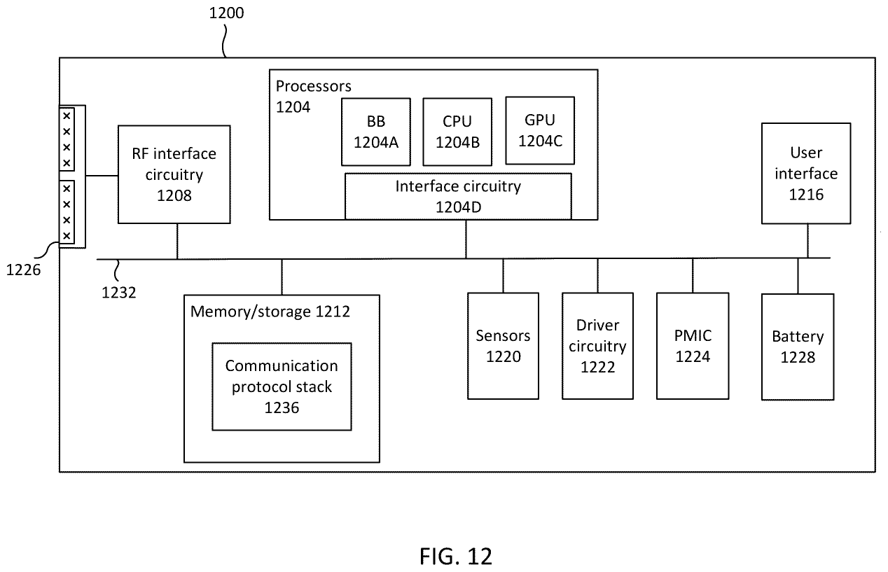

FIG. 12 illustrates a UE 1200 in accordance with some embodiments. The UE 1200 may be similar to and substantially interchangeable with the UE 104.

The UE 1200 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, or actuators), video surveillance/monitoring devices (for example, cameras or video cameras), wearable devices (for example, a smart watch), or Internet-of-things devices.

The UE 1200 may include processors 1204, RF interface circuitry 1208, memory/storage 1212, user interface 1216, sensors 1220, driver circuitry 1222, power management integrated circuit (PMIC) 1224, antenna 1226, and battery 1228. The components of the UE 1200 may be implemented as integrated circuits (ICs), portions thereof, discrete electronic devices, or other modules, logic, hardware, software, firmware, or a combination thereof. The block diagram of FIG. 12 is intended to show a high-level view of some of the components of the UE 1200. However, some of the components shown may be omitted, additional components may be present, and different arrangements of the components shown may occur in other implementations.

The components of the UE 1200 may be coupled with various other components over one or more interconnects 1232, which may represent any type of interface, input/output, bus (local, system, or expansion), transmission line, trace, or optical connection that allows various circuit components (on common or different chips or chipsets) to interact with one another.

The processors 1204 may include processor circuitry such as, for example, baseband processor circuitry (BB) 1204A, central processor unit circuitry (CPU) 1204B, and graphics processor unit circuitry (GPU) 1204C. The processors 1204 may include any type of circuitry or processor circuitry that executes or otherwise operates computer-executable instructions, such as program code, software modules, or functional processes from memory/storage 1212 to cause the UE 1200 to perform operations as described herein. The processors 1204 may also include interface circuitry 1204D to communicatively couple the processor circuitry with one or more other components of the UE 1200.

In some embodiments, the baseband processor circuitry 1204A may access a communication protocol stack 1236 in the memory/storage 1212 to communicate over a 3GPP compatible network. In general, the baseband processor circuitry 1204A may access the communication protocol stack 1236 to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a NAS layer. In some embodiments, the PHY layer operations may additionally/alternatively be performed by the components of the RF interface circuitry 1208.

The baseband processor circuitry 1204A may generate or process baseband signals or waveforms that carry information in 3GPP-compatible networks. In some embodiments, the waveforms for NR may be based on cyclic prefix OFDM (CP-OFDM) in the uplink or downlink, and discrete Fourier transform spread OFDM (DFT-S-OFDM) in the uplink.

The memory/storage 1212 may include one or more non-transitory, computer-readable media that includes instructions (for example, communication protocol stack 1236) that may be executed by one or more of the processors 1204 to cause the UE 1200 to perform various operations described herein.

The memory/storage 1212 includes any type of volatile or non-volatile memory that may be distributed throughout the UE 1200. In some embodiments, some of the memory/storage 1212 may be located on the processors 1204 themselves (for example, memory/storage 1212 may be part of a chipset that corresponds to the baseband processor circuitry 1204A), while other memory/storage 1212 is external to the processors 1204 but accessible thereto via a memory interface. The memory/storage 1212 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 1208 may include transceiver circuitry and a radio frequency front module (RFEM) that allows the UE 1200 to communicate with other devices over a radio access network. The RF interface circuitry 1208 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna 1226 and proceed to filter and amplify (with a low-noise amplifier) the signal. The signal may be provided to a receiver of the transceiver that down-converts the RF signal into a baseband signal that is provided to the baseband processor of the processors 1204.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1226.

In various embodiments, the RF interface circuitry 1208 may be configured to transmit/receive signals in a manner compatible with NR access technologies.

The antenna 1226 may include antenna elements to convert electrical signals into radio waves to travel through the air and to convert received radio waves into electrical signals. The antenna elements may be arranged into one or more antenna panels. The antenna 1226 may have antenna panels that are omnidirectional, directional, or a combination thereof to enable beamforming and multiple input, multiple output communications. The antenna 1226 may include microstrip antennas, printed antennas fabricated on the surface of one or more printed circuit boards, patch antennas, or phased array antennas. The antenna 1226 may have one or more panels designed for specific frequency bands including bands in FR1 or FR2.

The user interface 1216 includes various input/output (I/O) devices designed to enable user interaction with the UE 1200. The user interface 1216 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, and projectors), with the output of characters, graphics, multimedia objects, and the like being generated or produced from the operation of the UE 1200.

The sensors 1220 may include devices, modules, or subsystems whose purpose is to detect events or changes in their environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 1222 may include software and hardware elements that operate to control particular devices that are embedded in the UE 1200, attached to the UE 1200, or otherwise communicatively coupled with the UE 1200. The driver circuitry 1222 may include individual drivers allowing other components to interact with or control various input/output (I/O) devices that may be present within, or connected to, the UE 1200. For example, driver circuitry 1222 may include a display driver to control and allow access to a display device, a touchscreen driver to control and allow access to a touchscreen interface, sensor drivers to obtain sensor readings of sensors 1220 and control and allow access to sensors 1220, drivers to obtain actuator positions of electro-mechanic components or control and allow access to the electro-mechanic components, a camera driver to control and allow access to an embedded image capture device, audio drivers to control and allow access to one or more audio devices.

The PMIC 1224 may manage power provided to various components of the UE 1200. In particular, with respect to the processors 1204, the PMIC 1224 may control power-source selection, voltage scaling, battery charging, or DC-to-DC conversion.

A battery 1228 may power the UE 1200, although in some examples the UE 1200 may be mounted deployed in a fixed location and may have a power supply coupled to an electrical grid. The battery 1228 may be a lithium-ion battery, a metal-air battery, such as a zinc-air battery, an aluminum-air battery, a lithium-air battery, and the like. In some implementations, such as in vehicle-based applications, the battery 1228 may be a typical lead-acid automotive battery.

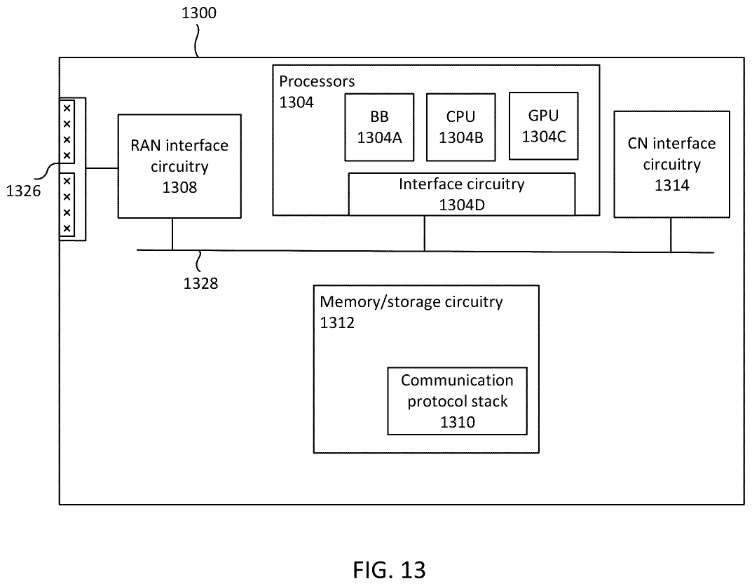

FIG. 13 illustrates a network device 1300 in accordance with some embodiments. The network device 1300 may be similar to and substantially interchangeable with base station 108, ground station 116 or NP 118.

The network device 1300 may include processors 1304, RF interface circuitry 1308 (if implemented as a base station), core network (CN) interface circuitry 1314, memory/storage circuitry 1312, and antenna structure 1326.

The components of the network device 1300 may be coupled with various other components over one or more interconnects 1328.

The processors 1304, RF interface circuitry 1308, memory/storage circuitry 1312 (including communication protocol stack 1310), antenna structure 1326, and interconnects 1328 may be similar to like-named elements shown and described with respect to FIG. 12.

The processors 1304 may include processor circuitry such as, for example, baseband processor circuitry (BB) 1304A, central processor unit circuitry (CPU) 1304B, and graphics processor unit circuitry (GPU) 1304C. The processors 1304 may include any type of circuitry or processor circuitry that executes or otherwise operates computer-executable instructions, such as program code, software modules, or functional processes from memory/storage circuitry 1312 to cause the UE 1200 to perform operations as described herein. The processors 1304 may also include interface circuitry 1304D to communicatively couple the processor circuitry with one or more other components of the network device 1300.

The CN interface circuitry 1314 may provide connectivity to a core network, for example, a 5th Generation Core network (5GC) using a 5GC-compatible network interface protocol such as carrier Ethernet protocols, or some other suitable protocol. Network connectivity may be provided to/from the network device 1300 via a fiber optic or wireless backhaul. The CN interface circuitry 1314 may include one or more dedicated processors or FPGAs to communicate using one or more of the aforementioned protocols. In some implementations, the CN interface circuitry 1314 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, or network element as described above in connection with one or more of the preceding figures may be configured to operate in accordance with one or more of the examples set forth below in the example section.

### EXAMPLES

In the following sections, further exemplary embodiments are provided.

Example 1 includes a method including: processing a beam-specific configuration of a serving beam, the beam-specific configuration received from a base station; and performing, by a user equipment (UE), a downlink (DL) reception or an uplink (UL) transmission on the serving beam based on the beam-specific configuration of the serving beam.

Example 2 includes the method of example 1 or some other examples herein, wherein the beam-specific configuration includes: a configuration associated with a beam-specific discontinuous transmission (DTX); a configuration of a beam-specific discontinuous reception (DRX); a configuration associated with a beam-specific DTX and a beam-specific DRX; or a configuration including an active duration and a non-active duration associated with the UL transmission or the DL reception on the serving beam.

Example 3 includes the method of examples 1 or 2 or some other example herein, further including: determining a UE capability parameter associated with supporting the beam-specific configuration; and generating a signal to transmit the UE capability parameter to the base station.

Example 4 includes the method of any of examples 1-3 or some other examples herein, further including: processing an activation command associated with the beam-specific configuration; and processing a deactivation command associated with the beam-specific configuration.

Example 5 includes the method of any of examples 1˜4 or some other examples herein, wherein: the activation command is included in a first downlink control information (DCI) and the deactivation command is included in a second DCI; or the activation command is included in a first medium access control (MAC) control element (CE) and the deactivation command is included in a second MAC CE.

Example 6 includes the method of any of examples 1-5 or some other examples herein, wherein the serving beam is a first beam, and the method further includes: switching from the first beam to a second beam; and determining that the beam-specific configuration is not valid.

Example 7 includes the method of any of examples 1-6 or some other examples herein, wherein the beam-specific configuration is a first beam-specific configuration, and the method further includes: processing a dedicated signaling or a group common signaling having a second beam-specific configuration.

Example 8 includes the method of any of examples 1-7 or some other examples herein, wherein the beam-specific configuration is a first beam-specific configuration, and the method further includes: processing a reconfiguration signaling including a second beam-specific configuration.

Example 9 includes the method of any of examples 1-8 or some other examples herein, wherein the beam-specific configuration is a first beam-specific configuration, and the method further includes: processing a second beam-specific configuration of a second beam; and processing one or more commands to deactivate the first beam-specific configuration, and to activate the second beam-specific configuration.

Example 10 includes the method of any of examples 1-9 or some other examples herein, wherein the one or more commands are included in one or more downlink control information (DCIs) or one or more medium access control (MAC) control elements (CEs).

Example 11 includes the method of any of examples 1-10 or some other examples herein, wherein the one or more commands are received using the first beam.

Example 12 includes the method of any of examples 1-11 or some other examples herein, wherein the beam-specific configuration is a first beam-specific configuration, and the method further includes: processing a second beam-specific configuration of the second beam; and determining that a measurement of the second beam is larger than a measurement of the first beam, wherein said switching from the first beam to the second beam is based on said determining that the measurement of the second beam is greater than the measurement of the first beam.

Example 13 includes the method of any of examples 1-12 or some other examples herein, further including: generating an indicator to be transmit to the base station, wherein the indicator: includes a first index associated with the second beam-specific configuration or a second index associated with the second beam; and indicates said switching from the first beam to the second beam.

Example 14 includes the method of any of examples 1-13 or some other examples herein, further including: performing a random-access procedure after said switching from the first beam to the second beam; and determining a beam change or a location change; and generating a measurement report associated with the second beam based on said determining the beam change or the location change.

Example 15 includes the method of any of examples 1-14 or some other examples herein, wherein the measurement report is a medium access control (MAC) control element (CE) report.

Example 16 includes a method including: generating a beam-specific configuration of a serving beam, the beam-specific configuration to be transmitted to a user equipment (UE); and performing a downlink (DL) transmission or an uplink (UL) reception on the serving beam based on the beam-specific configuration of the serving beam.

Example 17 includes the method of example 16 or some other examples herein, wherein the beam-specific configuration includes: a configuration associated with a beam-specific discontinuous transmission (DTX); a configuration of a beam-specific discontinuous reception (DRX); a configuration associated with a beam-specific DTX and a beam-specific DRX; or a configuration including an active duration and a non-active duration associated with the DL transmission and UL reception on the serving beam.

Example 18 includes the method of examples 16 or 17 or some other examples herein, further including: processing a UE capability parameter associated with supporting the beam-specific configuration; and determining the beam-specific configuration based on the UE capability.

Example 19 includes the method of any of examples 16-18 or some other examples herein, further including: generating an activation command associated with the beam-specific configuration, the activation command to be transmitted to the UE; and generating a deactivation command associated with the beam-specific configuration, the deactivation command to be transmitted to the UE.

Example 20 includes the method of any of examples 16-19 or some other examples herein, wherein: the activation command is included in a first downlink control information (DCI) and the deactivation command is included in a second DCI; or the activation command is included in a first medium access control (MAC) control element (CE) and the deactivation command is included in a second MAC CE.

Example 21 includes the method of any of examples 16-20 or some other examples herein, wherein the serving beam is a first beam, the beam-specific configuration is a first beam-specific configuration, and the method further includes: generating a dedicated signaling or a group common signaling including a second beam-specific configuration associated with a second beam.

Example 22 includes the method of any of examples 16-21 or some other examples herein, further including: generating, using the first beam, one or more commands to deactivate the first beam-specific configuration, and to activate the second beam-specific configuration.

Example 23 includes the method of any of examples 16-22 or some other examples herein, wherein the serving beam is a first beam, the beam-specific configuration is a first beam-specific configuration, further including: Processing and indicator received from the UE, the indicator including a first index a first index associated with a second beam-specific configuration or a second index associated with a second beam, the indicator to indicate a switching, by the UE, from the first beam to the second beam.

Example 24 includes a method including: processing a beam-specific access barring indication associated with a serving beam; and performing a downlink (DL) reception or an uplink (UL) transmission based on the beam-specific access barring indication.

Example 25 includes the method of example 24 or some other examples herein, wherein the beam-specific access barring indication includes a beam-specific cell barred indication, a beam-specific cell barred network energy saving (NES) indication, or a beam-specific user access control (UAC) indication.

Example 26 includes the method of examples 24 or 25 or some other examples herein, wherein the beam-specific access barring indication is included in a system information block (SIB).

Example 27 includes the method of any of examples 24-26 or some other examples herein, wherein the serving beam is a first serving beam, and the beam-specific access barring indication is a first beam-specific access barring indication, and the method further includes: processing a second beam-specific access barring indication associated with a second beam.

Example 28 includes the method of any of examples 24-27 or some other examples herein, wherein the second beam-specific access barring indication is included in the SIB.

Example 29 includes the method of any of examples 24-27 or some other example herein, wherein the SIB is a first SIB, and the second beam-specific access barring indication is included in a second SIB different from the first SIB.

Example 30 includes a method including: processing area information associated with a beam index; and performing a measurement associated with the beam index based on the area information.

Example 31 includes the method of example 30 or some other example herein, wherein the area information includes a center and a radius.

Example 32 includes the method of examples 31 or 32 or some other example herein, further including: generating a measurement result based on the area information.

Another example may include an apparatus comprising: processing circuitry to perform one or more elements of the method described in or related to any of examples 1-32, or any other method or process describe herein; and interface circuitry, coupled with the processing circuitry, the interface circuitry to communicatively couple the processing circuitry to one or more components of a computing platform.

Another example may include an apparatus comprising means to perform one or more elements of a method described in or related to any of examples 1-32, or any other method or process described herein.

Another example may include one or more non-transitory computer-readable media comprising instructions to cause an electronic device, upon execution of the instructions by one or more processors of the electronic device, to perform one or more elements of a method described in or related to any of examples 1-32, or any other method or process described herein.

Another example may include an apparatus comprising logic, modules, or circuitry to perform one or more elements of a method described in or related to any of examples 1-32, or any other method or process described herein.

Another example may include a method, technique, or process as described in or related to any of examples 1-32, or portions or parts thereof.

Another example may include an apparatus comprising: one or more processors and one or more computer-readable media comprising instructions that, when executed by the one or more processors, cause the one or more processors to perform the method, techniques, or process as described in or related to any of examples 1-32, or portions thereof.

Another example may include a signal as described in or related to any of examples 1-32, or portions or parts thereof.

Another example may include a datagram, information element, packet, frame, segment, PDU, or message as described in or related to any of examples 1-32, or portions or parts thereof, or otherwise described in the present disclosure.

Another example may include a signal encoded with data as described in or related to any of examples 1-32, or portions or parts thereof, or otherwise described in the present disclosure.

Another example may include a signal encoded with a datagram, IE, packet, frame, segment, PDU, or message as described in or related to any of examples 1-32, or portions or parts thereof, or otherwise described in the present disclosure.

Another example may include an electromagnetic signal carrying computer-readable instructions, wherein execution of the computer-readable instructions by one or more processors is to cause the one or more processors to perform the method, techniques, or process as described in or related to any of examples 1-32, or portions thereof.

Another example may include a computer program comprising instructions, wherein execution of the program by a processing element is to cause the processing element to carry out the method, techniques, or process as described in or related to any of examples 1-32, or portions thereof.

Another example may include a signal in a wireless network as shown and described herein.

Another example may include a method of communicating in a wireless network as shown and described herein.

Another example may include a system for providing wireless communication as shown and described herein.

Another example may include a device for providing wireless communication as shown and described herein.

Any of the above-described examples may be combined with any other example (or combination of examples) unless explicitly stated otherwise. The foregoing description of one or more implementations provides illustration and description but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method comprising:
processing a beam-specific configuration of a serving beam, the beam-specific configuration received from a base station; and
performing, by a user equipment (UE), a downlink (DL) reception or an uplink (UL) transmission on the serving beam based on the beam-specific configuration of the serving beam.

2. The method of claim 1, wherein the beam-specific configuration includes:
a configuration associated with a beam-specific discontinuous transmission (DTX);
a configuration of a beam-specific discontinuous reception (DRX);
a configuration associated with a beam-specific DTX and a beam-specific DRX; or
a configuration including an active duration and a non-active duration associated with the UL transmission or the DL reception on the serving beam.

3. The method of claim 1, further comprising:
determining a UE capability parameter associated with supporting the beam-specific configuration; and
generating a signal to transmit the UE capability parameter to the base station.

4. The method of claim 1, further comprising:
processing an activation command associated with the beam-specific configuration; and
processing a deactivation command associated with the beam-specific configuration.

5. The method of claim 4, wherein:
the activation command is included in a first downlink control information (DCI) and the deactivation command is included in a second DCI; or
the activation command is included in a first medium access control (MAC) control element (CE) and the deactivation command is included in a second MAC CE.

6. The method of claim 1, wherein the serving beam is a first beam, and the method further comprises:
switching from the first beam to a second beam; and
determining that the beam-specific configuration is not valid.

7. The method of claim 6, wherein the beam-specific configuration is a first beam-specific configuration, and the method further comprises:
processing a dedicated signaling or a group common signaling having a second beam-specific configuration.

8. The method of claim 6, wherein the beam-specific configuration is a first beam-specific configuration, and the method further comprises:
processing a reconfiguration signaling including a second beam-specific configuration.

9. The method of claim 6, wherein the beam-specific configuration is a first beam-specific configuration, and the method further comprises:
processing a second beam-specific configuration of a second beam; and
processing one or more commands to deactivate the first beam-specific configuration, and to activate the second beam-specific configuration.

10. The method of claim 9, wherein:
the one or more commands are included in one or more downlink control information (DCIs) or one or more medium access control (MAC) control elements (CEs); or
the one or more command are received using the first beam.

11. The method of claim 6, wherein the beam-specific configuration is a first beam-specific configuration, and the method further comprises:
processing a second beam-specific configuration of the second beam; and
determining that a measurement of the second beam is larger than a measurement of the first beam, wherein said switching from the first beam to the second beam is based on said determining that the measurement of the second beam is greater than the measurement of the first beam.

12. The method of claim 11, further comprising:
generating an indicator to be transmit to the base station, wherein the indicator:
includes a first index associated with the second beam-specific configuration or a second index associated with the second beam; and
indicates said switching from the first beam to the second beam.

13. The method of claim 12, further comprising:
performing a random-access procedure after said switching from the first beam to the second beam; and
determining a beam change or a location change; and
generating a measurement report associated with the second beam based on said determining the beam change or the location change.

14. The method of claim 13, wherein the measurement report is a medium access control (MAC) control element (CE) report.

15. An apparatus comprising:
processing circuitry to:
generating a beam-specific access barring indication associated with a serving beam; and
perform a downlink (DL) transmission or an uplink (UL) reception based on the beam-specific access barring indication; and
interface circuitry coupled with the processing circuitry to enable communication.

16. The apparatus of claim 15, wherein the beam-specific access barring indication includes a beam-specific cell barred indication, a beam-specific cell barred network energy saving (NES) indication, or a beam-specific user access control (UAC) indication.

17. The apparatus of claim 15, wherein the serving beam is a first serving beam, and the beam-specific access barring indication is a first beam-specific access barring indication, and the processing circuitry is further to:
generate a second beam-specific access barring indication associated with a second beam.

18. One or more non-transitory computer-readable media having instructions that, when executed, cause processing circuitry to:
process area information associated with a beam index; and
perform a measurement associated with the beam index based on the area information.

19. The one or more non-transitory computer-readable media of claim 18, wherein the instructions, when executed, further cause the processing circuitry to:
generate a measurement result based on the area information.

20. The one or more non-transitory computer-readable media of claim 18, wherein the area information includes a center and a radius and the instructions, when executed, further cause the processing circuitry to:
determine that a location of a user equipment (UE) is within a coverage area associated with the area information.
